(19) United States
(12) Patent Application Publication
(10) Pub. No.: US 2015/0219502 A1
(43) Pub. Date: Aug. 6, 2015

(54) HIGH TEMPERATURE SENSOR WITH A PROTECTIVE TUBE IN THE COLD SECTION

(71) Applicant: TESONA GMBH & CO.KG, Hörselberg/Hainich (DE)

(72) Inventor: Heiko Lantzsch, Eisenach (DE)

(21) Appl. No.: 14/428,894

(22) PCT Filed: Sep. 16, 2013
(86) PCT No.: PCT/EP2013/069155

§ 371 Date: Mar. 17, 2015

(30) Foreign Application Priority Data
Sep. 17, 2012 (DE) 20 2012 103 535.9

(51) Int. Cl. G01K 1/08; G01K 7/02; G01K 13/02

(52) U.S. Cl. CPC G01K 1/08; G01K 13/02; G01K 7/02

(57) ABSTRACT

The invention relates to a high temperature sensor, in particular for measuring the exhaust gas temperature of motor vehicles, comprising a hot section for arranging in the medium which is to be measured, a cold section for arranging on the outside of the medium which is to be measured, a sensor element comprising a measuring section in a hot section and a protective enveloping which at least partially surrounds the sensor element. A protective tube which at least partially surrounds the sensor element and/or the protective enveloping and which comprises a collar towards the hot section, is provided in the cold section. Preferably, said protective tube does not extend into the hot section.

### CROSS REFERENCE TO RELATED APPLICATIONS

This application claims priority under 35 U.S.C. §119 to PCT Application Number PCT/EP2013/069155 filed Sep. 16, 2013 and which claims priority to German patent document 20 2012 103 535.9, the entire contents of which are hereby incorporated by reference herein.

### BACKGROUND

High-temperature sensors of this type are used, for example, to measure the temperature in exhaust pipes of gasoline engines or in furnaces. They may be suited to measure temperatures of greater than 500° C. Especially when used in exhaust pipes in the automobile field, e.g. in exhaust gas cleaning systems, high-temperature sensors of this kind are exposed to high thermal and mechanical (due to the vibrations of the engine) loads. The sensor element for measuring the temperature is, therefore, typically protected by a protective envelope, in particular a protective tube, e.g. of metal.

Various high-temperature sensors, especially also for use in the automobile field, are known from the prior art. In particular, high-temperature sensors of this kind may be designed as sheath thermocouples.

DE 10 2008 060 033 A1 discloses a temperature sensor having a thermocouple, which includes a sheathed fireproof cable including a sensor element attached to the cable end facing the sample medium and featuring electric connecting leads that run through a casing tube of the sheathed cable for connecting the sensor element to an electronic evaluation unit. It is proposed to provide a protective sleeve which comprises a one-piece front part, without any welding points. In addition, it is proposed to provide the protective sleeve with a curvature on its front side facing the sample medium.

WO 2010/063682 A1 discloses a temperature sensor having a thermocouple, which includes a sheathed fireproof cable including a sensor element attached to the cable end facing the sample medium. Electric connecting leads run through a metal tube of the sheathed cable for connecting the sensor element to an electronic evaluation unit. The disclosed temperature sensor is to be usable for temperatures up to 1200° C., and capable of sensing fast temperature changes. To this end, the sensor element consists of a thermo wire bead which protrudes from the sheathed cable and is received by a protective envelope that is attached to the end of the sheathed cable facing the sample medium. The protective envelope comprises a one-piece front part, without any welding points, and the sheathed cable is a flexible thin-walled metal tube with a small outer diameter, with the connecting leads running through the section thereof pointing away from the sample medium and creating the desired interface with an on-board electronic system. The attachment of the temperature sensor to the measuring point is realized by a special ring collar and a union nut.

A high-temperature sensor having a sensor element mounted in a protective tube is disclosed in EP 2 196 787 A2. To allow reliable measurements also in high-temperature environments, e.g. the exhaust gas system of a motor vehicle, the protective tube is surrounded by a reinforcement tube, the reinforcement tube is composed of material whose coefficient of thermal expansion is higher than that of the material from which the protective tube is formed. The reinforcement tube is fixedly connected to the protective tube in a first region of the protective tube, and an abutment element is also fixedly connected to the protective tube in a second region of the protective tube. The reinforcement tube, owing to its greater thermal expansion, comes into mechanical contact with the abutment element above a predefined temperature, whereby the high-temperature sensor is mechanically stabilized above this temperature. The space between the sensor element and the protective tube cap of EP 2 196 787 A2 is filled with a material having good heat-conducting properties. In this case, fine silicon powder may be used. The stabilizing mechanical contacting of the protective tube with the abutment element requires a minimum temperature, so that particularly directly in the starting phase, respectively, the non-high-performance operation the overall arrangement tends to vibrate which may put the reliability of the measuring arrangement at risk. The high-temperature sensor can be fixed in the exhaust gas system by means of a mounting pod.

### SUMMARY

The present invention relates to a high-temperature sensor, in particular for measuring the exhaust gas temperature of motor vehicles, comprising a hot section for arrangement in the medium to be measured, a cold section for arrangement outside the medium to be measured, a sensor element having a measuring section in the hot section, and a protective envelope surrounding the sensor element at least partially.

It is an object of the present invention to provide a further developed high-temperature sensor which has a greater stability and can be produced inexpensively.

The high-temperature sensor disclosed below provides that a protective tube is formed in the cold section, which surrounds the sensor element and/or the protective envelope at least partially and which has a collar towards the hot section, wherein preferably the protective tube does not extend into the hot section.

Experiments have shown that, surprisingly, the protective tube arranged in the cold section of the high-temperature sensor also leads to a stabilization of the protective envelope and the sensor element in the hot section. Thus, a protective tube in the hot section, where higher requirements in terms of the material would have to be satisfied, may be waived.

Typically, the hot and the cold sections of the high-temperature sensor are separated by the holder, e.g. a fixing flange, by means of which the high-temperature sensor is fixed to the wall towards the hot space to be measured. In particular, the high-temperature sensor may be fixed by the collar to the manifold or the exhaust pipe, for instance, of a motor vehicle.

The hot section, respectively, the cold section of the high-temperature sensor may be, for instance, the hot half, respectively, the cold half, meaning there is the half of the high-temperature sensor that is pointing to the high temperature to be measured, respectively, the half that is pointing to the (comparatively) cooler holder.

Due to the fact that the stabilizing protective tube is mounted in the relatively colder region of the high-temperature sensor, the protective tube is exposed to smaller thermal loads. It thus maintains its stabilizing property more easily, respectively, a protective tube from a material having a smaller thermal resistance can be used.

The protective tube can be fixed to the holder by the collar. Furthermore, it is possible that the collar is adjacent to a fixing flange which is arranged around the sensor element and thus allows a firm connection to the sensor element.

In an embodiment of the invention it is provided that across the axial extension of the high-temperature sensor at least 80% of the cold section are surrounded by the protective tube and at most 20% of the hot section are covered by the protective tube.

In another embodiment of the invention it is provided that the collar is adjacent or fixed, in particular welded, to a support sleeve or a fixing flange.

In another embodiment of the invention it is provided that the collar comprises:
1. a first collar element running substantially radially to the outside from the tubular section of the protective tube, and
2. a second collar element running radially to the inside starting from the outer edge of the first collar element.

If the high-temperature sensor is mounted on a partition wall the second collar element can thus serve as a seal.

In another embodiment of the invention it is provided that the second collar element has the contour of a tooth lock washer.

Thus, it can be ensured that the high-temperature sensor is not unfastened.

In another embodiment of the invention it is provided that the protective envelope fully surrounds the sensor element except for an opening for the connections.

Thus, an optimum protection for the sensor element is obtained.

In another embodiment of the invention it is provided that the protective tube is made of a material which is dimensionally stable even at high temperatures, in particular of glass, ceramic, glass ceramic and/or polymer ceramic.

In another embodiment of the invention it is provided that the protective tube is formed with a rigidity which is greater than that of the sensor element and/or the protective envelope.

In another embodiment of the invention it is provided that the collar and/or the support element, respectively, the fixing flange includes a thread, in particular an external thread.

If the thread is formed directly on the collar of the protective tube, it is possible to use the collar directly for fixing the protective tube. An additional support element may thus not be necessary.

Alternatively, the collar may be fixed to a support element, e.g. a fixing flange.

In another embodiment of the invention it is provided that the protective tube is formed in one piece, wherein in particular the collar is formed by a widening of the protective tube facing the hot side.

A protective tube formed in one piece, including the collar, allows a particularly inexpensive production, with a high stability at the same time.

In another embodiment of the invention it is provided that the high-temperature sensor is or can be covered by a protective cap on the hot side.

In another embodiment of the invention it is provided that the protective tube is inseparably connected, in particular welded, to the support element.

In another embodiment of the invention it is provided that the protective tube has a higher coefficient of thermal expansion than the sensor element and/or the protective envelope.

Due to the higher coefficient of thermal expansion the protective tube is expanded relative to the sensor element in the event of a thermal load. The protective tube thus moves further around the sensor element, thus protecting it against mechanical, thermal or chemical loads.

The invention will be explained in more detail below by means of exemplary embodiments and with the aid of figures.

### BRIEF DESCRIPTION OF THE DRAWINGS

In the drawings:

FIG. 1a shows a top view to the hot side of a first high-temperature sensor;

FIG. 1b shows another top view to the cold side of the high-temperature sensor of FIG. 1a;

FIG. 1c shows a cross-sectional view of the high-temperature sensor of FIG. 1a;

FIG. 1d shows another cross-sectional view of the high-temperature sensor of FIG. 1a;

FIG. 2a shows a top view to the hot side of a second high-temperature sensor;

FIG. 2b shows a top view to the hot side of a second high-temperature sensor;

FIG. 2c shows a cross-sectional view of the high-temperature sensor of FIG. 2a; and

FIG. 2d shows another cross-sectional view of the high-temperature sensor of FIG. 2a

### DETAILED DESCRIPTION

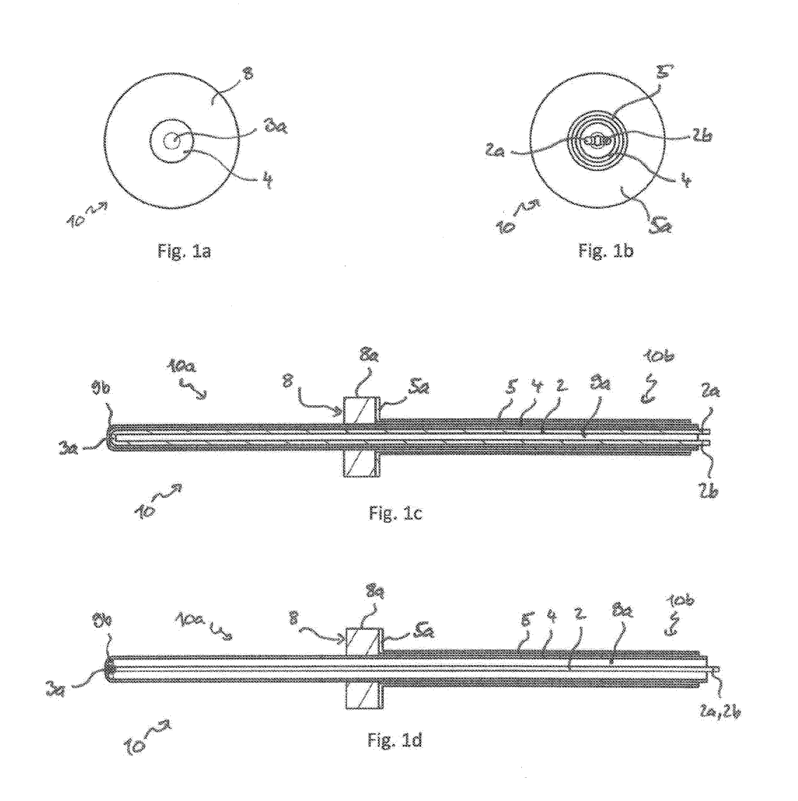

FIG. 1a shows a top view to the hot side of a first high-temperature sensor 10. The protective envelope 4 and the measuring bead 3a are visible.

FIG. 1b shows a top view to the cold side of the high-temperature sensor of FIG. 1a. The two electrical connections 2a, 2b, the protective envelope 4 and the protective tube 5 with collar 5a are visible.

FIG. 1c shows a first cross-sectional view of the high-temperature sensor of FIG. 1a. The hot section 10a extends from the tip of the high-temperature sensor 10 to the fixing flange 8. The cold section 10b extends from the fixing flange 8 to the electrical connections 2a, 2b. The sensor element 2 runs axially through the high-temperature sensor 10. The measuring section 3 is, in this case, realized by a measuring bead 3a. The sensor element 2 is directly surrounded by a heat-conducting material 9b. Around the latter a protective envelope 4 is arranged. Except for the electrical connections 2a, 2b the protective envelope 4 fully encloses the sensor element 2.

On the cold section 10b the protective envelope 4 is surrounded by a strong protective tube 5. The protective tube 5 is adjacent with its collar 5a to the fixing flange 8. The fixing flange 8 has an outer thread 8a by means of which the high-temperature sensor 10 can be fixed, for instance, to an exhaust gas system.

FIG. 1d shows a second longitudinal cross-sectional view, illustrating a plane which is orthogonal to the cutting plane of FIG. 1c. The round shape of the measuring bead 3a is visible.

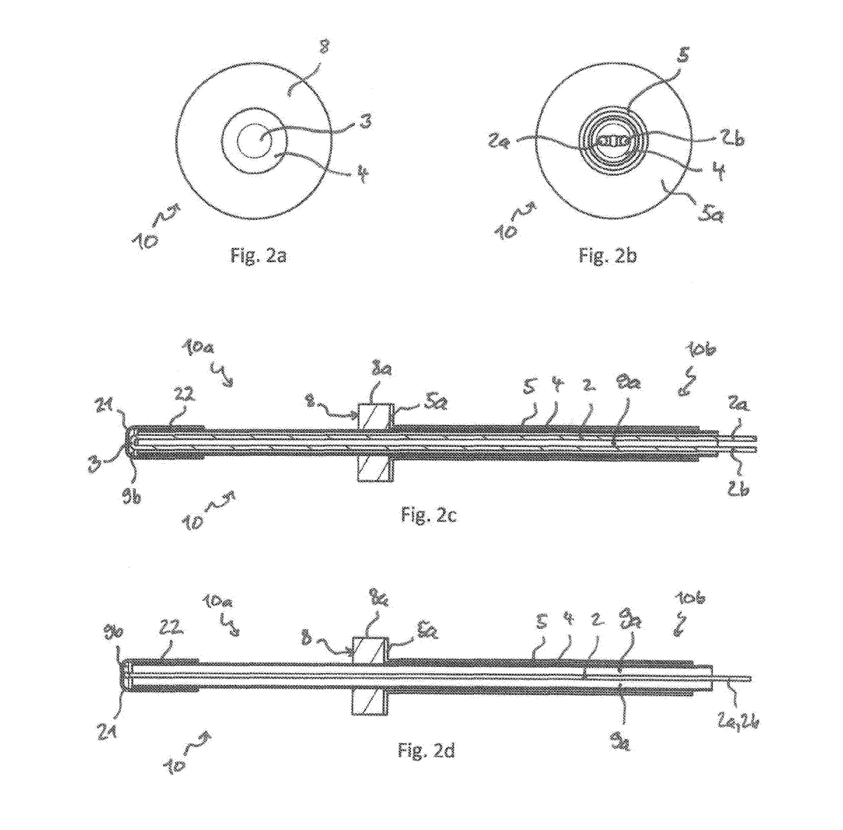

The high-temperature sensor 20 shown in a top view from the hot and cold sides in FIGS. 2a and 2b, and in a longitudinal cross-sectional view in FIGS. 2c and 2d, is formed comparably to the first high-temperature sensor 10 shown of Figures la to 1d. In a modification thereof, the high-temperature sensor 20 includes a protective cap 20 which surrounds the protective envelope 4 in the region of the measuring section 3.

1. A high-temperature sensor (10) for measuring the exhaust gas temperature of motor vehicles, comprising:
a hot section (10a) for arrangement in a medium to be measured,
a cold section (10b) for arrangement outside the medium to be measured,
a sensor element (2) having a measuring section (3; 3a) in the hot section, and
a protective envelope (4) surrounding the sensor element at least partially,
wherein, a protective tube (5) is provided in the cold section, which surrounds the sensor element (2) and/or the protective envelope (4) at least partially and which has a collar (5a) proximate the hot section (10a), and
wherein the protective tube (5) does not extend into the hot section (10a).

2. The high-temperature sensor according to claim 1, characterized in that across an axial extension of the high-temperature sensor (10) at least 80% of the cold section (10b) is surrounded by the protective tube and at most 20% of the hot section (10a) is covered by the protective tube (5).

3. The high-temperature sensor according to claim 1, characterized in that the collar (5a) is adjacent or fixed to a support sleeve or a fixing flange (8).

4. The high-temperature sensor according to claim 1, characterized in that the collar (5a) comprises:
a first collar element running substantially radially to an outside from a tubular section of the protective tube, and
a second collar element running radially to an inside starting from an outer edge of the first collar element.

5. The high-temperature sensor according to claim 4, characterized in that the second collar element has the contour of a tooth lock washer.

6. The high-temperature sensor according to claim 1, characterized in that the protective envelope (4) fully surrounds the sensor element (2) except for an opening for the connections (2a; 2b) of the sensor element (2).

7. The high-temperature sensor according to claim 1, characterized in that the protective tube (5) is made of at least one of glass, ceramic, glass ceramic, and polymer ceramic.

8. The high-temperature sensor according to claim 1, characterized in that the protective tube (5) is formed with a rigidity which is greater than that of the sensor element and/or the protective envelope.

9. The high-temperature sensor according to claim 1, characterized in that the fixing flange (8) includes a thread (8a).

10. The high-temperature sensor according to claim 1, characterized in that the protective tube (5) is formed in one piece, wherein the collar (5a) is formed by a widening of the protective tube (5) facing the hot side.

11. The high-temperature sensor according to claim 1, characterized in that the high-temperature sensor is covered by a protective cap (21) on the hot side.

12. The high-temperature sensor according to claim 3, characterized in that
the protective tube (5) is inseparably connected to the support element (8), and
the protective tube (5) has a higher coefficient of thermal expansion than the sensor element (2) and/or the protective envelope (4).

13. The high-temperature sensor according to claim 3, characterized in that the protective envelope (4) fully surrounds the sensor element (2) except for an opening for connections (2a; 2b) of the sensor element (2).

14. The high-temperature sensor according to claim 3, characterized in that the protective tube (5) is formed with a rigidity which is greater than that of the sensor element and/or the protective envelope.

15. The high-temperature sensor according to claim 3, characterized in that the protective tube (5) is formed in one piece, wherein the collar (5a) is formed by a widening of the protective tube (5) facing the hot side.

16. The high-temperature sensor according to claim 4, characterized in that the protective envelope (4) fully surrounds the sensor element (2) except for an opening for connections (2a; 2b) of the sensor element (2).

17. The high-temperature sensor according to claim 4, characterized in that the protective tube (5) is formed with a rigidity which is greater than that of the sensor element and/or the protective envelope.

18. The high-temperature sensor according to claim 4, characterized in that the protective tube (5) is formed in one piece, wherein the collar (5a) is formed by a widening of the protective tube (5) facing the hot side.

19. The high-temperature sensor according to claim 7, characterized in that the protective tube (5) is formed with a rigidity which is greater than that of the sensor element and/or the protective envelope.

20. The high-temperature sensor according to claim 1, wherein the collar (5a) comprises:
an annular disk arranged around a first portion of the protective tube, and
an element surrounding a second portion of the protective tube that extends from the annular disk and away from the measuring section.
